(19) United States
(12) Patent Application Publication
(10) Pub. No.: US 2017/0329831 A1
(43) Pub. Date: Nov. 16, 2017

(54) SYSTEM AND METHOD FOR ANALYZING CONTENT USAGE EVENTS

(71) Applicant: ACLIPSA MOBILE VIDEO SOLUTIONS, LLC, BROWNSVILLE, WI (US)

(72) Inventors: Steven R. Michels, Jupiter, FL (US); Matthew Wayne Frederick, Phoenix, AZ (US)

(21) Appl. No.: 15/593,205

(22) Filed: May 11, 2017

Related U.S. Application Data
(60) Provisional application No. 62/334,983, filed on May 11, 2016.

(51) Int. Cl. G06F 17/30; G06F 11/30; G06F 11/34

(52) U.S. Cl. CPC G06F 17/30563; G06F 17/30958; G06F 11/302; G06F 11/3438

(57) ABSTRACT

The method and system disclosed herein includes a computer-implemented method of analyzing content usage events. The method entails receiving usage events that include commands and identifiers that indicate positions in a content at which each of the commands occurred, and creating a record of usage events that occurred for a single session. Commands for usage events may pertain to playing, pausing, stopping, rewinding, fast-forwarding, and scrubbing the content (video and/or audio content) as well as scrolling, panning, and zooming.

### CROSS-REFERENCE TO RELATED APPLICATION(S)

This application claims the benefit of U.S. Provisional Application No. 62/334,983 filed on May 11, 2016, the content of which is incorporated herein by reference in its entirety.

### BACKGROUND

### 1. Field of the Invention

This invention relates to a method and apparatus for determining content usage pattern.

### 2. Related Art

Digital media is more popular today than ever before, fueled by ubiquity of portable electronic devices (e.g., tablets and smartphones) and increasing communication network bandwidth availability and speeds. Hence, digital contents are downloaded and streamed today more than ever before. Naturally, digital media is increasingly used as the preferred platform to deliver various kinds of data, and contents that used to be delivered via traditional print media are rapidly migrating to digital formats. For example, while books and prints used to be the main platforms for educational and instructional purposes, a lot of teaching happens via digital media today.

With digital media becoming more widely used for different purposes, it becomes more important for content providers to understand how their content is being viewed. For example, a provider of an instructional content (e.g., video clip) would want to know if any part of its instructional presentation is unclear or confusing, so that that part can be improved or supplemented. Similarly, a movie provider may want to know if there is a segment of the movie that is watched more than the rest. While there are methods available for generally tracking how often a certain piece of digital content is viewed, purchased, or downloaded, information about how the content is consumed (e.g., viewed, listened to, or otherwise used) is desired.

### SUMMARY

In one aspect, the method and system disclosed herein includes a computer-implemented method of analyzing content usage events. The method entails receiving usage events that include commands and identifiers that indicate positions in a content at which each of the commands occurred, and creating a record of usage events that occurred for a single session.

In another aspect, the disclosure pertains to a system that includes a first set of computer-readable instructions to detect usage events regarding playing, pausing, stopping, rewinding, fast-forwarding, and scrubbing while consuming a content at a first computing device, and to transmit the usage events, and a second set of computer-readable instructions to detect usage events regarding playing, pausing, stopping, rewinding, fast-forwarding, and scrubbing while consuming a content at a second computing device, and to transmit the usage events. A third set of computer-readable instructions receives the usage events that were transmitted according to the first set of computer-readable instructions and the second set of computer-readable instructions and generates a usage report based on patterns of usage.

### BRIEF DESCRIPTION OF THE DRAWINGS

FIG. 1 illustrates a content distribution and analysis system in accordance with an embodiment of the inventive concept.

FIG. 2 illustrates data flow among the devices of the content distribution and analysis system in accordance with an embodiment of the inventive concept.

FIG. 3A and FIG. 3B illustrate data flow among the devices of the content distribution and analysis system in accordance with other embodiments of the inventive concept.

FIG. 4 illustrates an example of a usage event analysis report for a single content at a single device.

FIG. 5 depicts a flowchart of a usage report generation process in accordance with an embodiment of the inventive concept.

FIG. 6 illustrates an example of a usage report generated based on aggregation of usage events from multiple devices for a single content.

FIG. 7 illustrates an example of a usage report generated based on tracking an individual end user's usage over a given time period.

FIG. 8 is a block diagram illustrating an example computer system that may be used to implement an embodiment of the inventive concept.

### DETAILED DESCRIPTION

The method and system disclosed herein pertains to collecting and analyzing content consumers' usage activities to extract useful information. An end user device transmits usage events to a usage analyzer. The usage analyzer is able to collect usage events for different contents from a single user, as well as usage events from many different end user devices. Using the vast collection of data, the usage analyzer can determine frequently-occurring patterns for each end user device, each end user, and for specific content. Further, the usage analyzer can determine patterns for a group of end users, end user devices, and/or a class/category of content. Example embodiments will be described below, with the understanding that variations of the specifically-described embodiments are contemplated. For example, while much of the description is provided in the context of streaming video and audio, this is not a limitation of the inventive concept.

“Content,” as used herein, refers to visual and/or audio data, videos, images, documents, texts, etc. “Usage event,” as used herein, refers to a user-activated consumption function such as Play, Pause, Stop, Rewind, Fast Forward, scrubbing, scrolling, panning, and zooming. In addition, “usage event” also includes an indicator of at which points in the content (e.g., how much time into the content) the above functions were activated. A “viewer” and a “user” are herein used interchangeably. Although the disclosure focuses on digital content, the inventive concept is not so limited and may be applied to other types of data that is suitable.

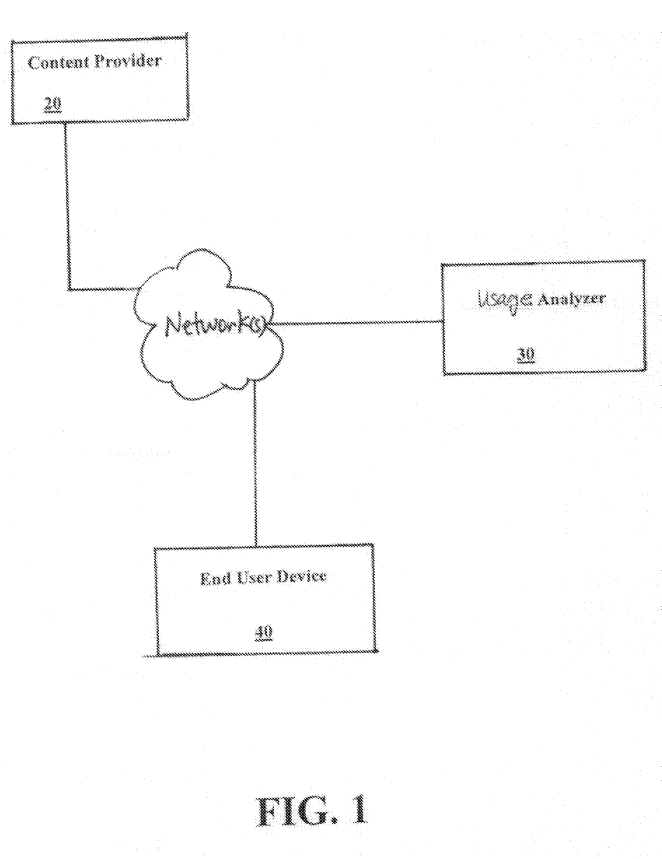

FIG. 1 is an example embodiment of the content distribution and analysis system 10 in accordance with the inventive concept. As shown, the content distribution and analysis system 10 includes a content provider 20, usage analyzer 30, and an end user device 40 communicating with one another via a communications network. The content provider 20 may be one or more computer systems, each of which is configured to encode video and/or audio streams associated with digital media content files for streaming. Popular examples of content providers 20 include Netflix, Hulu, and YouTube, among others. The encoded video and audio streams are transmitted via the communications network to the end user device 40. The end user device 40, which may be a desktop, laptop, smartphone, tablet, a console, or television system among other possibilities, is configured to produce a display image and any associated sound for the viewer. The viewer controls the end user device 40 to access the content and activate various usage functions as desired (e.g., play, pause, rewind). The usage analyzer 30 collects data regarding usage events to determine usage pattern and user behavior.

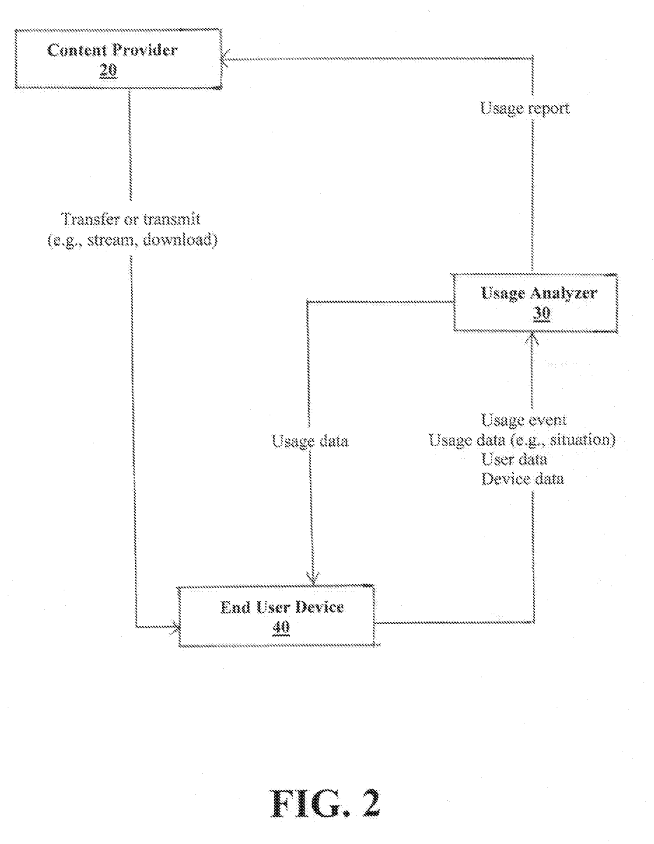

FIG. 2 illustrates data flow among the devices of the content distribution and analysis system 10 in accordance with an embodiment of the inventive concept. As shown, content provider 20 is configured to serve requests for digital media content files from the end user 40. Thus, upon receiving a content selection from the end user device 40, content data is streamed, downloaded, or otherwise transmitted to the end user device 40. The digital media content files may reside on a mass storage system accessible to the content provider 20. The content provider 20 includes a software component for encoding one or more audio and video streams associated with a specific content title for streaming. “Streaming,” as used herein, is intended to mean a sequential transmission of digital media content files from the content provider 20 to the end user device 40, wherein the end user plays the digital media content file while content data is received. To account for variable latency and bandwidth within the communications network, a content buffer queues the incoming content data ahead of the content data actually being played. During moments of network congestion, which leads to lower available bandwidth, less content data is added to the content buffer, which may drain down as content data is being de-queued to support usage at a certain usage bit rate. However, during moments of high network bandwidth, the content buffer is replenished and additional buffer time is added until the content buffer is generally full again. In practical systems, the content buffer may queue content data corresponding to a time span ranging from seconds to more than a minute.

Although only one end user device 40 is shown in FIG. 1 and FIG. 2 for clarity and convenience of illustration, there are in fact multiple end user devices 40 that communicate with the usage analyzer 30.

Data is streamed, downloaded, or otherwise transferred (e.g., in a storage medium) from the content provider 20 to the end user device 40, and used or consumed by the end user device 40. When this usage or consumption happens, the end user device 40 tracks and records usage events. A usage event includes a user action, such as a request to play a specific content or activating a specific function such as Play, Pause, Fast Forward, etc. along with an indication of at which point in the content the respective functions were activated. A usage event may include the date and time the usage event began, the start position in the content when the event began, and the end position in the content when the event ended.

The usage analyzer 30 tracks the usage events based on consumption (e.g., in case of a video, the playback), independently of a stream or how the content reached the end user device 40. The start and end positions of a content are determined based on specific implementations of the content usage software system or electronic device, and may be intentionally engaged by a user or automatically recorded. For the sake of clarity, this disclosure focuses on an embodiment where the start position and end position in a content are marked in terms of the content timeline (e.g., how long into the content the Viewer is). However, it should be understood that other ways to record the start and end positions of a usage event are contemplated. For example, in some embodiments, usage events may be recorded as a function of the SHI headers or frame numbers instead of timeline. The usage events are transmitted to the usage analyzer 30.

Some examples of usage event start positions are as follows:
Engaging the “Play” function of a content that was not playing
Resuming the “Play” function of a content that was paused
Allowing usage to begin or continue after using the “Fast Forward” function for a content
Allowing usage to begin or continue after engaging the “Rewind” function for a content
Allowing usage to begin or continue after the “Scrub” function was used to set the play position to a specific point for a content

Some examples of usage event end positions are as follows:
Engaging the “Stop” function for a content that was playing
Engaging the “Pause” function for a content that was playing
Engaging the “Fast Forward” function for a content that was playing
Engaging the “Rewind” function for a content that was playing
Engaging the “Scrub” function to begin setting the play function for a content

In the embodiment of FIG. 2, the usage analyzer 30 receives or generates a unique identifier for the user. Optionally, various personal information about the user (e.g., address, phone number, age, gender, profession) may also be provided to the usage analyzer 30. Furthermore, data about the end user device 40, such as what electronic device is being used for content consumption, what software is used, the geographical location of the electronic device, and what usage mode/speed is used, may also be provided to the usage analyzer 30. In some cases, the end user device 40 may also receive usage data about the situation in which the usage occurred. An example of a situation is resumed usage starting at the beginning of the part of the content that was skipped. Another example is being visually shown which part of the content were and were not consumed. More specifically, Usage data may include playback resumption points (including at the start of skipped-over portions, not just the last playback position), user-specific usage status and/or patterns, other users' usage (e.g., what is generally popular).

Usage events may be analyzed in multiple ways and in multiple places. In one embodiment, usage events may be recorded and stored on the end user device 40 and transmitted to a usage analyzer 30 periodically, either in response to a request by the user or usage analyzer 30, or automatically according to pre-programmed instructions (e.g., after a title has been viewed to the end, after a title has not been viewed for a prescribed duration such as 3 days, or at a certain time of day). Alternatively, the transmission may happen upon request from the usage analyzer 30. The usage analyzer 30 may analyze the usage events in real time, or at a later time.

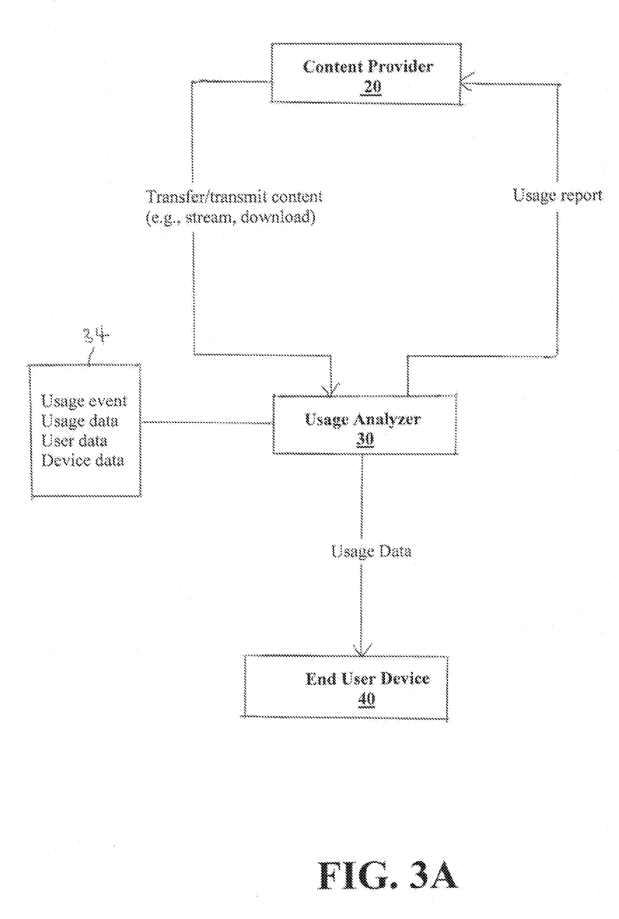

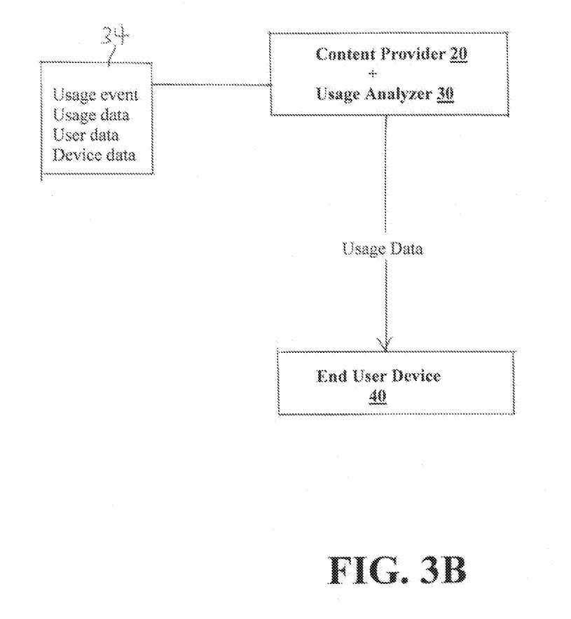

FIG. 3A depicts a second embodiment of the content distribution and analysis system in accordance with the inventive concept. In this embodiment, the end user device 40 receives the desired content through the usage analyzer 30 instead of directly from the content provider 20. In one implementation, an end user who has an account with the usage analyzer 30 logs in to his account and selects the content he wants to consume from an interface provided by the usage analyzer 30. The usage analyzer 30 receives the selected content from an appropriate content provider 20, for example in the form of a stream or download. Usage data may be included in the transmission from the content provider 20.

When the end user device activates various usage functions (e.g., Play, Pause, Rewind), the activated function and the point at which the command was activated (e.g., a certain amount of time into the content) are recorded. The recording may be done at the end user device and transmitted to the usage analyzer 30. Alternatively, the recording may be done directly by the usage analyzer 30 because the end user is receiving the content and activating the control functions through the interface provided by the usage analyzer 30. The recorded information may be stored in a storage 34 accessible to the usage analyzer 30, as usage event.

FIG. 3B depicts a third embodiment of the content distribution and analysis system in accordance with the inventive concept. In this embodiment, the usage analyzer 30 is also the content provider 20. A single entity, for example, may have the usage analysis capability and a storage for content that will be watched by the end user device 40. Like in FIG. 2 and FIG. 3A, the end user device 40 may receive various usage data from the usage analyzer 30.

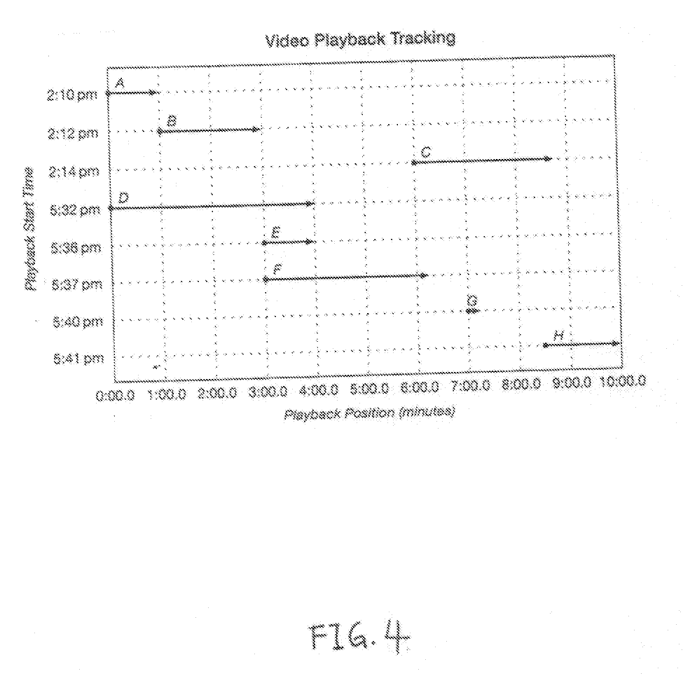

FIG. 4 is depicts an example record of a video usage/playback event tracking. As shown, an end user's consumption/viewing of a particular video is tracked and recorded as a series of usage events A through H, which tracks activities from a single device or a single user for a single content in a usage session. In this example, the usage events are shown as horizontal lines on a graph that shows video timeline along the horizontal axis and clock time at the start of an event along the vertical axis. The beginning of a horizontal line marks the start position of a usage event, and the end of a horizontal line marks the end position of a usage event. A quick look at the graph shows that all 10 minutes of the video was played, and some segments were played twice or even three times. A more detailed interpretation of the usage events and situation data is as follows:
Usage event A (2:10 pm to 2:11 pm)
   Played from position 0:00.0 to position 1:00.0
   Played the first minute of the video
Usage event B (2:12 pm to 2:14 pm)
   Played from position 1:00.0 to position 3:00.0
   Events A and B together indicate that Viewer paused or stopped for one minute, then resumed usage for two minutes
Usage event C (2:14 pm to 2:16:40 pm)
   Played from position 6:00.0 to position 8:45.0
   Events B and C together indicate that Viewer scrubbed ahead to position 6:00 and immediately continued usage for 2 minutes and 45 seconds
Usage event D (5:32 pm to 5:36 pm)
   Played from position 0:00.0 to position 4:00.0
   Events C and D together indicate that Viewer did not play video for 3 hours and 15 minutes. Viewer restarted usage from beginning of video and played for 4 minutes.
   Events A, B, C, and D together indicate that Viewer took a break and started vide from the beginning
Usage event E (5:36 pm to 5:37 pm)
   Played from position 3:00.0 to position 4:00.0
   Events D and E together indicate that Viewer scrubbed back to position 3:00 and immediately replayed the most-recently-played 1 minute
Usage event F (5:37 pm to 5:40:10 pm)
   Played from position 3:00.0 to position 6:15.0
   Events E and F together indicate that Viewer scrubbed back to position 3:00 and immediately replayed the most-recently-played 1 minute, and continued playing for an additional 2 minutes and 15 seconds.
   Events D, E, and F together indicate that the portion of the video from position 3:00 to position 4:00 was played repeatedly, in immediate succession. This might indicate that, for example, that the particular minute of video is especially interesting or confusing
Usage event G (5:40:30 pm to 5:40:40 pm)
   Played from position 7:00.0 to position 7:15.0
   Events F and G together indicate that Viewer scrubbed ahead to 7:00. This might be due to noticing at the end that this part has already been viewed (in usage C). Then played for 15 seconds.
Usage event H (5:41:30 pm to 5:43 pm)
   Played from position 8:30.0 to position 10:00.0
   Events G and H together indicate that Viewer scrubbed ahead to 8:30, then played to the end of the video.
   Events F, G, and H possibly indicate that Viewer was seeking ahead to find an unplayed portion.

In Event A, 10% of the video content was viewed. In Events A, B, and C together, which is before the long break was taken, Viewer watched 57.5% of the video. In Events C, D, F, and H together, Viewer watched 100% of the video.

The usage analyzer 30 may analyze the usage patterns of a single end user device 40, a single user, a group of end user devices 40, or a group of users. The usage analyzer 30 is configured to aggregate the records received from all the end user devices in the system 10. One or more usage events may be grouped into a single usage session based on predefined criteria, such as the date and time of the events. For example, suppose an end user device 40 recorded multiple Plays, Pauses, and Rewinds over a period of 1.5 hours on a single content, creating a series of usage events. All the usage events in this 1.5-hour period may be grouped into a single usage session to help analyze how the particular content was consumed. The usage events can also be used to determine whether a single user consumed the entire content in order to, for example, determine compliance or accreditation. Reviewing similar types of data from multiple end user devices 40 may enable generation of a pattern about which parts of the particular content are frequently subject to “Rewind” function.

Conversely, the usage analyzer 30 may analyze a particular content for who views it, how, when, and where. Contents may also be grouped according to genre, year of release, rating, reviews, nationality, length, etc.

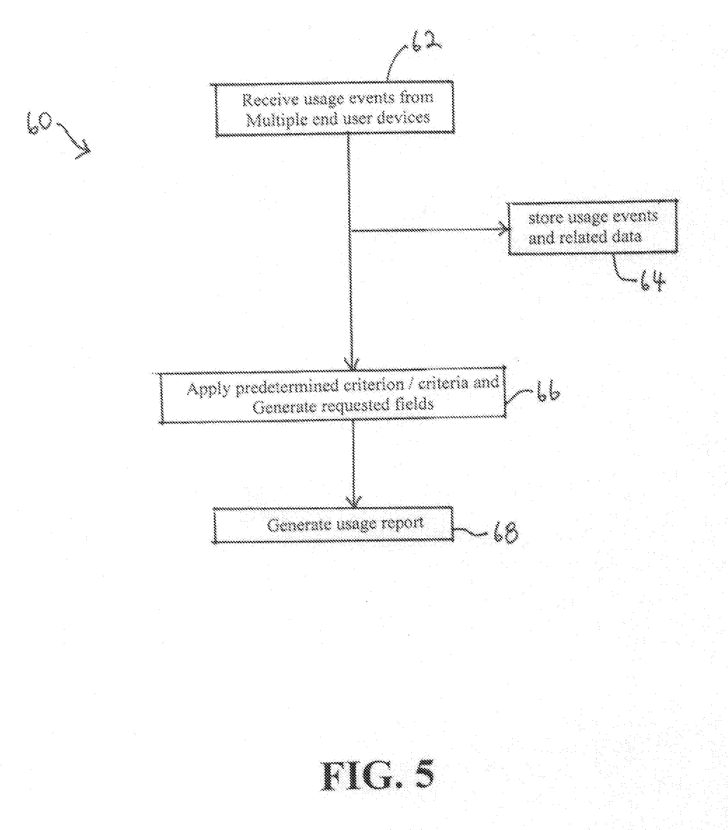

FIG. 5 depicts a flowchart of the usage analysis process 60 performed at the usage analyzer 30. As shown, the usage analyzer 30 receives usage events from multiple end user devices 40 (step 62). The received usage events and related data (e.g., usage data, user data, device data, situation data) may be stored (step 64). For example, each usage session may be stored as a tracking record of the type that is illustrated in FIG. 4. Then, the predetermined criterion/criteria are applied to the data to generate requested fields (step 66). The predetermined criterion/criteria may be for certain devices, such as devices at certain geographic locations, devices of certain brands/types, usage times, etc. The predetermined criterion/criteria may be for users who may be grouped according to demographic criteria such as age or gender. The more information a user is asked to provide at initial registration with the usage analyzer 30 to open an account, the more options there will be for analyzing usage patterns and preferences of different groups or for the individual user. The requested fields are produced by aggregating the data from all the devices that satisfy the predetermined criterion/criteria. Optionally, the usage analyzer may provide usage reports to the content provider 20 summarizing the patterns and preferences of viewers.

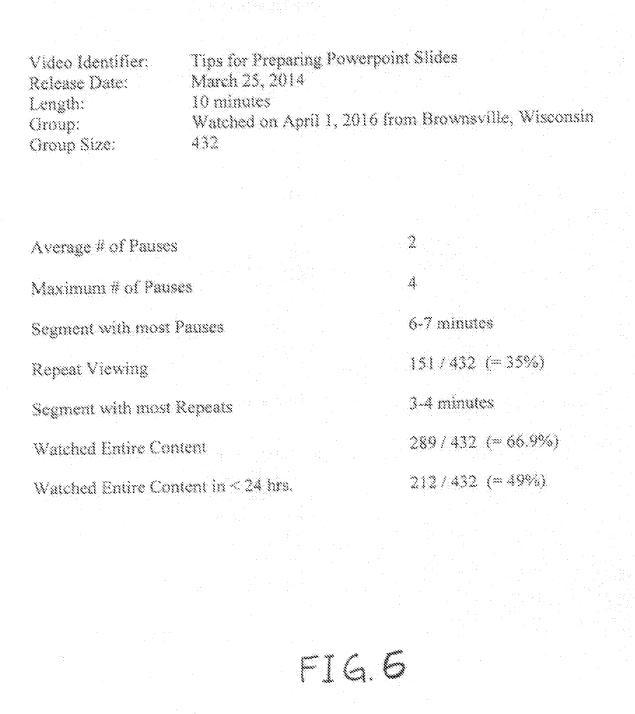

FIG. 6 provides an example of a usage report that may be generated by the usage analyzer 30. As shown, this usage report pertains to a single content, “Tips for Preparing PowerPoint Slides” released on Mar. 25, 2014. The predetermined criteria that was applied to generate this report are: 1) watched on Apr. 1, 2016 on 2) devices that are located in Brownsville, Wis. The usage report indicates that the data presented is a result of aggregating information from 432 devices, all of which satisfied the two predetermined criteria.

As shown, seven fields were requested for the usage report. In the particular example that is shown, the seven fields are: Average number of pauses, Maximum number of pauses, segment with most Pauses, Number of Repeat Viewings, Segment that was most frequently subjected to repeat viewing, number of viewings that was for the entire content, and the number of viewings where the entire content was viewed in a 24-hour window. One of the useful usage patterns that can be obtained by the usage analyzer 30 relates to if a content was consumed in its entirety (e.g., >90% of it), hardly viewed (e.g., <10%), or partially viewed. These are fields are just examples and not intended to be an exhaustive list of all possibilities.

In generating the usage report, the usage analyzer 30 may add fields that are not requested if there are actions that are unusually high in frequency. For example, if there is a segment that was viewed often in a repeated manner, that piece of information may be “voluntarily” added to the usage report even if the high-repeat-viewing field was not chosen for the report. Likewise, if a group of users in a specific geographic area is viewing content of a certain genre or type in an unusually high frequency, that information may be added to the report.

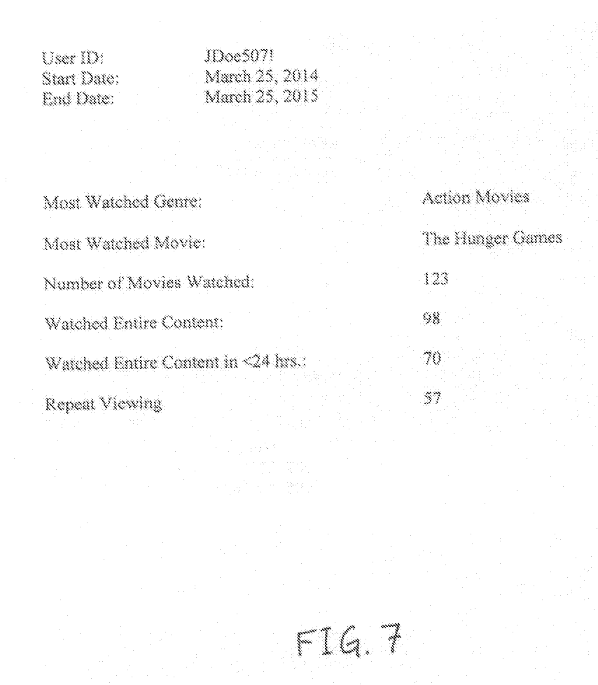

FIG. 7 provides an example of a usage report based on analysis performed on a single user. The example report is for a specific user identified by the identifier “JDoe507!” as was assigned when the user opened his account with the usage analyzer 30. The report shows that this report is based on an approximately one-year time period starting on Mar. 25, 2014. Based on all the usage data collected on JDoe507!, it is determined what genre of movies is watched the most, how many movies were watched in their entireties, how many of those movies were viewed more than once, etc. This type of data may be helpful in determining compliance with a regulatory standard or accreditation. For example, if an employee is required to watch a safety video in order to work on a jobsite, the Usage data will be helpful in confirming that the entire video was indeed watched. In another example, if a nurse or a lawyer has to watch and/or listen to a content and review a document in order to receive Continuing Medical Accreditation (CME) credits or Minimum Continuing Legal Education (MCLE) credits, the Usage data can be similarly helpful in confirming that the requirements were fulfilled.

While the example embodiments above are provided in the context of streaming or downloaded content (e.g., movies, videos), the inventive concept may be adapted to track usage of texts, images, documents, and other data that may be downloaded or otherwise obtained. More specifically, usage patterns at various sections of a document may be determined by tracking how the document is viewed, scrolled, “flipped” (page up or down), skipped, etc. Similarly, usage patterns at various sections of an image may be determined by tracking how the image is viewed, scrolled, panned, zoomed, etc.

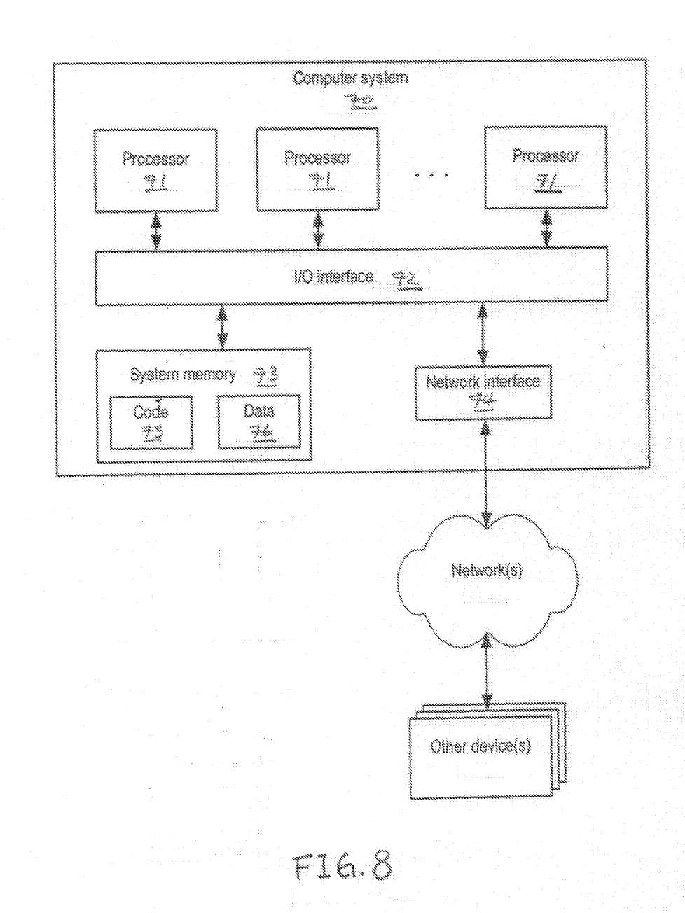

The usage analyzer 30 described above, as well as the content provider 20 and the end user device 40, may be implemented in a computing device. The computing device may include a general-purpose computer system 70 that includes or is configured to access one or more computer-readable media, such as the computer system illustrated in FIG. 8. In the illustrated embodiment, the computer system includes one or more processors 71 coupled to a system memory 73 via an input/output interface 72. Computer system further includes a network interface 74 coupled to the I/O interface 72. The processors 71 may be any suitable processors capable of executing instructions and implementing any of a variety of instruction set architectures (ISAs), such as the x86, PowerPC, SPARC, or MIPS ISAs, among other possibilities. In multiprocessor systems, each of processors may commonly, but not necessarily, implement the same ISA.

System memory may be configured to store instructions and data accessible by processor(s). In various embodiments, system memory may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory as code 75 and data 76.

In one embodiment, I/O interface 72 may be configured to coordinate I/O traffic between processor 71, system memory 73, and any peripheral devices including network interface 74 or other peripheral interfaces. In some embodiments, I/O interface 72 may perform any necessary protocol, timing or other data transformations to convert data signals from one component (e.g., system memory) into a format suitable for use by another component (e.g., processor). In some embodiments, I/O interface may include support for devices attached through various types of peripheral buses, such as a variant of the Peripheral Component Interconnect (PCI) bus standard or the Universal Serial Bus (USB) standard, for example. In some embodiments, the function of I/O interface may be split into two or more separate components, such as a north bridge and a south bridge, for example. Also, in some embodiments some or all of the functionality of I/O interface 72, such as an interface to system memory, may be incorporated directly into processor 71.

Network interface 74 may be configured to allow data to be exchanged between computer system and other devices attached to a network or networks, such as other computer systems or devices. In various embodiments, network interface may support communication via any suitable wired or wireless general data networks, such as types of Ethernet network. Additionally, network interface may support communication via telecommunications/telephony networks such as analog voice networks or digital fiber communications networks, via storage rea networks such as Fiber Channel SANs, or via any other suitable type of network and/or protocol.

While the embodiments are described in terms of a method or technique, it should be kept in mind that the disclosure may also cover an article of manufacture that includes a non-transitory computer readable medium on which computer-readable instructions for carrying out embodiments of the method are stored. The computer readable medium may include, for example, non-transitory storage media such as semiconductor, magnetic, opto-magnetic, or optical media (e.g. disk or DVD/CD) coupled to computer system via I/O interface. A non-transitory computer-readable storage medium may also include any volatile or non-volatile media such as RAM (e.g., SDRAM, DDR, DRAM, RDRAM, SRAM) or ROM. Further, a computer-readable medium may include transmission media or signals such as electrical, electromagnetic, or digital signals conveyed via a communication medium such as a network and/or a wireless link, such as may be implemented via network interface. Further, the disclosure may also cover apparatuses for practicing embodiments of the invention. Such apparatus may include circuits, dedicated and/or programmable, to carry out operations pertaining to embodiments.

Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to the embodiments.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A computer-implemented method of analyzing content usage events, comprising:
receiving usage events that include commands and identifiers that indicate positions in a content at which each of the commands occurred; and
creating a record of usage events that occurred for a single session.

2. The computer-implemented method of claim 1, wherein each of the identifiers comprises an amount of time into the content.

3. The computer-implemented method of claim 1, wherein a usage event comprises a start position and an end position.

4. The computer-implemented method of claim 3, wherein the start position comprises at least one of the following:
engaging “Play” function of the content when the content was not playing;
engaging “Play” function of the content when the content was paused;
continuing to play the content after using the “Fast Forward” function;
continuing to play the content after using the “Rewind” function; and
continuing to play the content after the “Scrub” function was used to set the play position to a specific point in the content.

5. The computer-implemented method of claim 3, wherein the end position comprises at least one of the following:
engaging “Stop” function when the content is playing;
engaging “Pause” function when the content is playing;
engaging “Fast Forward” function when the content is playing;
engaging “Rewind” function when the content is playing; and
engaging “Scrub” function for the content.

6. The computer-implemented method of claim 3, further comprising creating a usage event record for a usage session, the usage event record comprising a graph having points in the content along a horizontal axis and a usage event start position along a vertical axis.

7. The computer-implemented method of claim 1 further comprising:
receiving usage events and identifiers from a plurality of devices; and
forming a group of devices by selecting one or more of the devices according to a predefined criterion; and
generating a usage report based on aggregate analysis of usage events received from the group of devices.

8. A system, comprising:
a first set of computer-readable instructions to detect usage events regarding playing, pausing, stopping, rewinding, fast-forwarding, scrubbing, scrolling, panning, and zooming while consuming a content at a first computing device, and to transmit the usage events;
a second set of computer-readable instructions to detect usage events regarding playing, pausing, stopping, rewinding, fast-forwarding, and scrubbing while consuming a content at a second computing device, and to transmit the usage events; and
a third set of computer-readable instructions receiving the usage events that were transmitted according to the first set of computer-readable instructions and the second set of computer-readable instructions and generating a usage report based on patterns of usage.

9. The system of claim 8, wherein patterns of usage comprise same usage event applied to a same position in the content by the first and the second computing devices.

10. The system of claim 8, wherein a usage event comprises a start position and an end position.

11. The system of claim 10, wherein the start position comprises at least one of the following:
engaging “Play” function of the content when the content was not playing;
engaging “Play” function of the content when the content was paused;
continuing to play the content after using the “Fast Forward” function;
continuing to play the content after using the “Rewind” function; and
continuing to play the content after the “Scrub” function was used to set the play position to a specific point in the content.

12. The system of claim 10, wherein the end position comprises at least one of the following:
engaging “Stop” function when the content is playing;
engaging “Pause” function when the content is playing;
engaging “Fast Forward” function when the content is playing;
engaging “Rewind” function when the content is playing; and
engaging “Scrub” function for the content.
